(19) United States
(12) Patent Application Publication
(10) Pub. No.: US 2013/0132102 A1
(43) Pub. Date: May 23, 2013

(54) SMART PARKING SPACE ALLOCATION SYSTEM AND METHOD

(71) Applicants: Rajiv A. S. G. de Andrade, Sao Paulo (BR); Leonardo R. Augusto, Campinas/ SP (BR); Vitor L. Faria, Minas Gerais (BR); Lucas G. Franco, Sao Paulo (BR); Leonardo Marcelino, Sao Paulo (BR); Thiago C. Rotta, Sao Paulo (BR)

(72) Inventors: Rajiv A. S. G. de Andrade, Sao Paulo (BR); Leonardo R. Augusto, Campinas/ SP (BR); Vitor L. Faria, Minas Gerais (BR); Lucas G. Franco, Sao Paulo (BR); Leonardo Marcelino, Sao Paulo (BR); Thiago C. Rotta, Sao Paulo (BR)

(73) Assignee: INTERNATIONAL BUSINESS MACHINES CORPORATION, Armonk, NY (US)

(21) Appl. No.: 13/298,665

(22) Filed: Nov. 17, 2011

(51) Int. Cl. G06Q 50/10

(52) U.S. Cl. 705/1.1

(57) ABSTRACT

The present disclosure relates generally to parking space allocation systems and methods, and particularly, to parking space allocation systems and methods for use in connection with parking at a mall.

### BACKGROUND

The present disclosure relates generally to parking space allocation systems and methods, and particularly, to parking space allocation systems and methods for use in connection with parking at a mall.

### SUMMARY

As described herein, in one embodiment a method implemented by at least one computer for allocating a parking space in a parking lot of a mall is provided. In this embodiment, the allocation is for a first user from a plurality of users, the allocation is made after a vehicle arrives at an entrance to the parking lot, and the mall has a plurality of commercial establishments associated therewith. Further, in this embodiment the method comprises the steps of:
receiving into a database associated with the at least one computer a plurality of license plate ID's
receiving into the database associated with the at least one computer at least one of:
   (a) a plurality of user preferences, each of the user preferences being associated with one of the plurality of users and each of the user preferences being associated with one of the license plate ID's;
   (b) a plurality of shopping histories, each of the shopping histories being associated with one of the plurality of users, each of the shopping histories comprising data indicative of at least one purchase made by a respective user from at least one of the commercial establishments, and each of the shopping histories being associated with one of the license plate ID's; and
   (c) a plurality of scheduled events, each of the scheduled events being associated with one of the plurality of users, each of the scheduled events comprising data indicative of at least one scheduled event associated with a respective user in connection with at least one of the commercial establishments, and each of the scheduled events being associated with one of the license plate ID's;
determining, by the at least one computer, a license plate ID of the vehicle at the entrance to the parking lot;
obtaining from the database associated with the at least one computer at least one of: (a) one or more user preferences corresponding to the determined license plate ID; (b) one or more shopping histories corresponding to the determined license plate ID; and (c) one or more scheduled events corresponding to the determined license plate ID; and
allocating, by the at least one computer, a parking space for the first user, wherein the allocation of the parking space is based at least in part upon at least one of: (a) the one or more user preferences corresponding to the determined license plate ID; (b) the one or more shopping histories corresponding to the determined license plate ID; and (c) the one or more scheduled events corresponding to the determined license plate ID.

As described herein, in another embodiment a system for allocating a parking space in a parking lot of a mall is provided. In this embodiment, the allocation is for a first user from a plurality of users, the allocation is made after a vehicle arrives at an entrance to the parking lot, and the mall has a plurality of commercial establishments associated therewith. Further, in this embodiment the system comprises one or more processor units configured for:
receiving into a database a plurality of license plate ID's;
receiving into the database at least one of:
   (a) a plurality of user preferences, each of the user preferences being associated with one of the plurality of users and each of the user preferences being associated with one of the license plate ID's;
   (b) a plurality of shopping histories, each of the shopping histories being associated with one of the plurality of users, each of the shopping histories comprising data indicative of at least one purchase made by a respective user from at least one of the commercial establishments, and each of the shopping histories being associated with one of the license plate ID's; and
   (c) a plurality of scheduled events, each of the scheduled events being associated with one of the plurality of users, each of the scheduled events comprising data indicative of at least one scheduled event associated with a respective user in connection with at least one of the commercial establishments, and each of the scheduled events being associated with one of the license plate ID's;
determining a license plate ID of the vehicle at the entrance to the parking lot;
obtaining from the database at least one of: (a) one or more user preferences corresponding to the determined license plate ID; (b) one or more shopping histories corresponding to the determined license plate ID; and (c) one or more scheduled events corresponding to the determined license plate ID; and
allocating a parking space for the first user, wherein the allocation of the parking space is based at least in part upon at least one of: (a) the one or more user preferences corresponding to the determined license plate ID; (b) the one or more shopping histories corresponding to the determined license plate ID; and (c) the one or more scheduled events corresponding to the determined license plate ID.

As described herein, in another embodiment an article of manufacture is provided. In this embodiment, the article of manufacture comprises at least one tangible computer readable device having a computer readable program code logic tangibly embodied therein to execute at least one machine instruction in a processing unit. The computer readable program code logic is for allocating a parking space in a parking lot of a mall. The allocation is for a first user from a plurality of users, the allocation is made after a vehicle arrives at an entrance to the parking lot, and the mall has a plurality of commercial establishments associated therewith. Further, in this embodiment the computer readable program code logic, when executing, performs the following steps:
receiving into a database a plurality of license plate ID's;
receiving into the database at least one of:
   (a) a plurality of user preferences, each of the user preferences being associated with one of the plurality of users and each of the user preferences being associated with one of the license plate ID's;
   (b) a plurality of shopping histories, each of the shopping histories being associated with one of the plurality of users, each of the shopping histories comprising data indicative of at least one purchase made by a respective user from at least one of the commercial establishments, and each of the shopping histories being associated with one of the license plate ID's; and
   (c) a plurality of scheduled events, each of the scheduled events being associated with one of the plurality of users, each of the scheduled events comprising data indicative of at least one scheduled event associated with a respective user in connection with at least one of the commercial establishments, and each of the scheduled events being associated with one of the license plate ID's;
determining a license plate ID of the vehicle at the entrance to the parking lot;
obtaining from the database at least one of: (a) one or more user preferences corresponding to the determined license plate ID; (b) one or more shopping histories corresponding to the determined license plate ID; and (c) one or more scheduled events corresponding to the determined license plate ID; and
allocating a parking space for the first user, wherein the allocation of the parking space is based at least in part upon at least one of: (a) the one or more user preferences corresponding to the determined license plate ID; (b) the one or more shopping histories corresponding to the determined license plate ID; and (c) the one or more scheduled events corresponding to the determined license plate ID.

### BRIEF DESCRIPTION OF THE DRAWINGS

Various objects, features and advantages of the present invention will become apparent to one skilled in the art, in view of the following detailed description taken in combination with the attached drawings, in which:

FIG. 1 depicts a block diagram of a system according to one embodiment of the present invention;

FIG. 2 depicts a block diagram of a system according to one embodiment of the present invention;

FIG. 3 depicts a block diagram of a system according to one embodiment of the present invention; and

FIG. 4 depicts a block diagram of a system according to one embodiment of the present invention.

### DETAILED DESCRIPTION

For the purposes of describing and claiming the present invention the term “vehicle” is intended to refer to a car, a truck, a bus, an SUV, a motorcycle, or the like.

For the purposes of describing and claiming the present invention the term “license plate ID” is intended to refer to the numeric, alphabetic, or alphanumeric identity assigned to a vehicle, as shown on the vehicle's license plate or the like.

For the purposes of describing and claiming the present invention the term “mall” is intended to refer to any grouping of commercial establishments having associated therewith a parking lot. In one example, the parking lot may be a multi-level parking lot. In another example, the parking lot may be an enclosed parking lot. In another example, the parking lot may be a restricted access parking lot (e.g., having entry and exit controlled by a gate or the like).

For the purposes of describing and claiming the present invention the term “physical purchase” is intended to refer to a purchase made in person at a “brick and mortar” commercial establishment (e.g., made in person at a retail store).

For the purposes of describing and claiming the present invention the term “on-line purchase” is intended to refer to a purchase made electronically and remotely, such as by using a web browser in communication with a website via the Internet.

In one example, various embodiments may infer the user's probable destination or destinations (based, for example, on the user's shopping history, the user's preferences, parking lot usage history and/or forecast of the parking lot usage at a desired time (e.g., a time indicated by the user implicitly or explicitly).

In another example, various embodiments may handle (e.g., add to a database) scheduled events (such as buying a ticket for a movie on the next Tuesday at 8 PM).

In another example, various embodiments may calculate the probability of finding an available parking space in a parking lot, on a particular date and time (e.g., a time of a scheduled event).

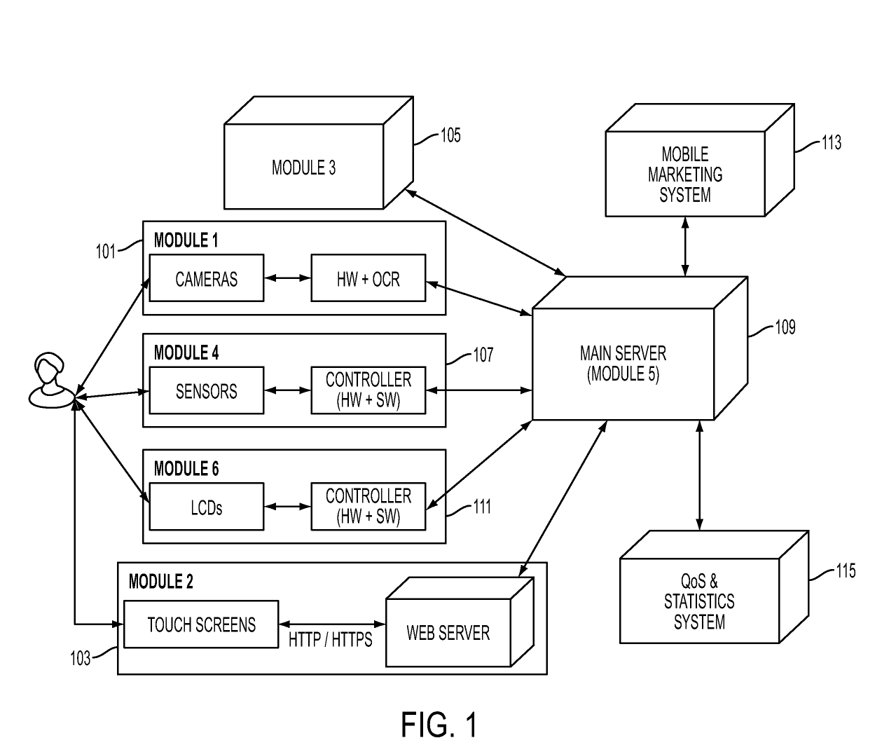

Referring now to FIG. 1, a block diagram according to one embodiment of the present invention is shown. This embodiment may guide each driver to a particular parking space, by using each vehicle's license plate as the identity information. The parking space to which each driver is guided may be based not only on the availability of the parking space but also on the special needs and/or desires of each driver and/or passenger.

As seen in this FIG. 1 (which is an architecture overview of an example smart parking system), the system may include a number of modules. More particularly, the system may include the following modules:

Module 1—element 101. Module 1 may comprise a mechanism (including, for example, one or more cameras and corresponding Optical Character Recognition (“OCR”) hardware/software capable of reading and identifying the following symbols associated with each of the vehicles that are entering the parking lot:
license plate; and/or
the International Symbol of Access (“ISA”), also known as the Wheelchair Symbol.

Module 2—element 103. Module 2 may comprise a “manual” destination selection device, to be placed at the parking lot's entrance, in which the user is presented with a list of stores in that mall and is able to select his desired destination. This device may also be used by users as a terminal to search for where they parked their vehicles and localize it in the parking lot when they are leaving the mall. In one example, this module may comprise one or more touch screens and a web server.

Module 3—element 105. Module 3 may comprise a webportal or website mechanism which stores, in a database (not shown), each user's preferences, each user's scheduled events (e.g., a particular user bought a ticket for a movie at a certain date and time), each user's online shopping history for stores in that particular mall, the license plate ID of each user' vehicle(s), sellers advertisement(s), setup data, etc.)

Module 4—element 107. Module 4 may comprise a mechanism to gather information from a sensor network and determine what the available parking spaces in the parking lot are. In one example, this module may comprise one or more controllers having hardware and software.

Module 5—element 109. Module 5 may comprise a mechanism that, given a license plate ID, gathers (and/or calculates): (a) the respective user preferences; (b) the respective user scheduled events (c) the respective user probable destination; (d) the location of the available parking spaces; and then calculates what's the best parking space/region for that specific user at that specific time.

Module 6—element 111. Module 6 may comprise a network-capable mechanism including a number of displays, intended to inform the user the directions to a certain parking space. In one example, this module may comprise one or more controllers having hardware and software.

The system may further include a Mobile Marketing System—element 113 (described in more detail below) and/or a QoS (Quality of Service) & Statistics system—element 115 (described in more detail below) for compiling usage/operational statistics and determining/reporting on various statistics and on quality of service.

In various examples, one or more of the following applications may be provided:
reserve a certain parking space, near the entrance, for an elderly user who is entering the parking lot;
detect if the user reserved tickets for a movie, reserved a table for dinner or bought a product at a website of one of the stores and:
   guide him/her to the available parking space closest to that theater/store; and/or
   warn the restaurant/store that the user has just arrived (e.g., to enable the restaurant/store to speed up any needed process);
gather the user preferences and shopping history and suggest a parking space near the store(s) to which the user usually goes.

Of note, in one example, as the license plate of each vehicle parked in each parking space would be known and correlated to that parking space, it would be possible for the customer to check where exactly he parked the vehicle, when he's leaving the mall.

As described herein, various embodiments may utilize cameras positioned near the parking lot's entrance to identify the vehicle's license plate ID. This may be accomplished, for example, by any desired method known to one of ordinary skill in the art. An example of this identification process is described in U.S. Pat. No. 6,553,131 in the name of Neubauer et al., entitled LICENSE PLATE RECOGNITION WITH AN INTELLIGENT CAMERA (which is incorporated herein by reference in its entirety).

In any case, after the vehicle's license plate ID is recognized, one or more of the following additional steps may be carried out:
load the stored preferences of the user(s) associated with that license plate ID, if any;
load the user's shopping history in that particular mall, if any;
look for the International Symbol of Access in or on the vehicle;
analyze the faces of the people inside the vehicle, looking for elderly people.

In various examples, parameters used to calculate the best parking space for the vehicle may include (but not be limited to):
Shopping center nearest entrance;
Store to which the user wants to go;
The mall's entrance to which the user wants to go (in case he has missed the correct parking lot entrance).

In various examples, strategies to show the user the information to find the correct parking space may include (but not be limited to):
After entering the parking lot, the user would be guided to a certain parking space. This can be done by using a set of devices, located in each turn or bifurcation in the parking lot. Each device may include a camera (to identify the vehicle's license plate ID), a network device (to determine what was the parking space allocated to that vehicle) and an LCD (to show the user the right direction from that point on).
A low cost solution would be to monitor the overall state of each sector in the parking lot and simply inform the user, in the parking lot entrance or in the mall's website (e.g., after reserving a space or buying tickets), the sector or row in which he should park. Based on that information, the user can simply follow static transit signs to find the correct area.

In various examples, a statistics/forecast module (e.g., QoS & Statistics System 115 of FIG. 1) may perform one or more of the following functions:
Save information about the usage history of every sector in the parking lot based, for example, on the time (e.g., 9 AM, 10 PM . . . ) and day (e.g., holidays, weekends, business days). This module may provide a set of standard queries that might be used by the parking lot allocation system, such as (for example):
   i) amount of vehicles entering the parking lot on a certain day/period in the past;
   ii) usage of a certain parking sector on a certain day/period in the past; and/or
   iii) forecast the usage of a certain parking sector on a certain date/time in the future. For instance, consider the example where the user wants to reserve a parking space next to retail store “A”, on Friday Dec. 24, 2010, at 6 PM:
      a) get additional info about the target date. Is it a holiday, the day before a holiday, the day after a holiday, weekend or business day?
      b) get the useful statistics for this date:
         usage history of this sector on Fridays, during all the day
         usage history of this sector in all days before a holiday in the past year and in this year
         usage history of this sector in Dec. 24, 2009, 2008, 2007 . . .
      c) calculate the mean and standard deviation for all the values above
   iv) calculate the probability of finding an available parking space at the desired time
   v) calculate the probability of finding an available parking space during the entire day.

In various examples, a destination selection device (e.g., Module 2—element 103 of FIG. 1) may optionally be placed in the parking lot's entrance. This destination selection device may provide the user with a list of the stores in that mall and may enable the user to select one or more stores as his destination. In one specific example, the device might comprise an LCD and keyboard; a touch screen LCD; or a LCD and a voice recognition software.

Reference will now be made to various example usage scenarios:

Scenario 1: The camera identifies the International Symbol of Access in or on the vehicle and/or recognizes elderly people inside the vehicle.
The system may determine the list of available parking spaces reserved for elderly people and may gather information about the user preferences based on the vehicle's license plate ID. Based on the user preferences and the list of available parking spaces, the system can reserve a certain parking space near to the closest building entrance or near to the entrance closest to the store to which the user is probably going to (e.g., based on his shopping history). The system then shows the user the needed information to get there.

Scenario 2: The user, while buying online movie tickets (or making restaurant reservations, or buying one or more items), entered his vehicle license plate ID at an e-commerce website.
The system detects the previously entered license plate ID. The system then determines the list of available parking spaces nearest to the movie complex/restaurant/store entrance. The system then shows the user the needed information to get there.
The system can also send a notification to the movie complex/restaurant/store, warning that the user has just arrived. This information can be used to trigger a certain process and reduce the user service time.
Another option is to enable the user to access the mall's web website and enable the user to define/set his intended destinations on that mall website and also enter his vehicle's license plate ID. The system could then send the user an e-mail (or any other notification) informing him of:
what is his reserved parking space (if the parking lot control system in that mall is able to reserve parking spaces);
the calculated best parking area based on the selected stores;
what's the best times for parking in that area, based on the parking lot usage history and statistics (this may be determined by the system using use the statistics/forecast module).

In another example, the mall's website may be accessed by the sellers who do commerce in the mall. These sellers can define\set advertisements & other messages which will be sent to users by the Mobile Marketing System—element 113 of FIG. 1.

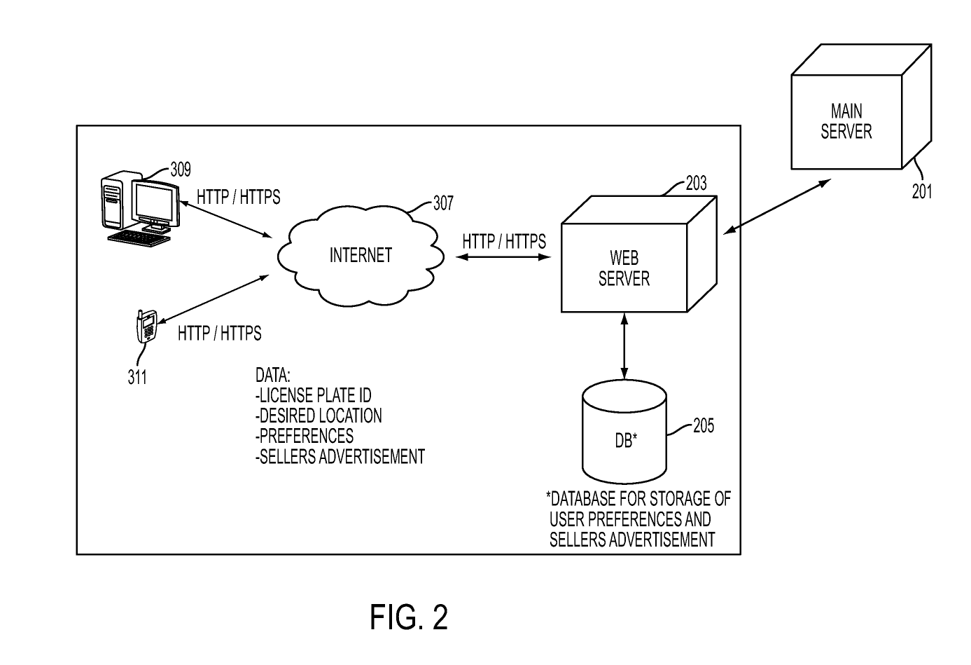

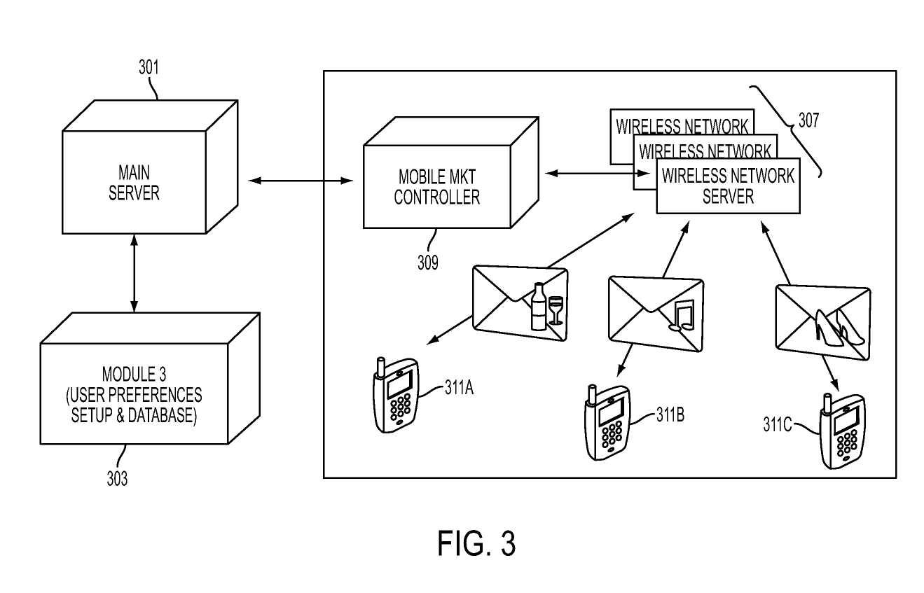

An extension of the architectural overview of FIG. 1 can be found in FIG. 2. This FIG. 2 shows details corresponding to Module 3—element 105 of FIG. 1 and how the system interacts with the user and sellers, while the user and sellers are defining preferences (users), advertisements (sellers) and/or messages (sellers) using, e.g., the mall's website. Of note, the Main Server—element 201 of FIG. 2 corresponds to Module 5—element 109 of FIG. 1 and both the web server—element 203 and DB (database)—element 205 of FIG. 2 correspond to Module 3—element 105 of FIG. 1. Also seen in this FIG. 3 are Internet 307, client computer 309 and client mobile device 311. Of further note, as in FIG. 1, the database of FIG. 2 may store each user's preferences, each user's scheduled events (e.g., a particular user bought a ticket for a movie at a certain date), each user's on-line shopping history for stores in that particular mall, the license plate ID of each user's vehicle(s), sellers advertisement, setup data, etc.

Scenario 3: The user informs the system of which store he's going to (the user wants to find the nearest available parking space).
At each parking lot entrance there would be a destination selection device (see Module 2—element 103 of FIG. 1) to show the user the list of stores in that mall, so that the user can choose his destination. The system may then determine the list of available parking spaces closest to the desired destination and show the user the needed information for him to get there.
The Module 3—element 105 of FIG. 1, and its details (shown in FIG. 2) can control and support the destination selection device(s) and can connect the destination selection device(s) to the mall's system (e.g., server system). That way, the user preferences and information may be stored in the same database and can be accessed by the other modules of the system.

Scenario 4: When leaving the mall, the user wants to find his vehicle.
When the user finish his activities at the mall, he can use a device (it might be placed next to the mall entrances/exits), comprising, for example, an LCD with touch screen capability, to provide his license plate ID to the system and get, as a result, the location of his vehicle in the parking lot. As the system had previously calculated the parking space for the user, this information can be retrieved to remind the user where his vehicle is located.
In one example, this device might be a computer with a web browser accessing the parking lot control system through a web-based interface. The same interface can be provided in the mall's website, making it accessible through a smart phone or any other network-capable device.

Scenario 5: The user doesn't have his preferences saved in the system (a new user).
At each parking lot entrance there would be destination selection device (see Module 2 —element 103 of FIG. 1). If the system doesn't recognize and/or find the license plate ID in the database (e.g., a new user), the user can simply choose his destination using the device. The system then creates a new entry in the database for this new user and then determines the list of available parking spaces closest to the desired destination and shows the user the needed information for him to get there.

Scenario 6: Integration with a mobile marketing system:
Using the user information and after the input of some advertisement(s) from seller(s), the system interacts with a module which promotes and implements a Mobile Marketing solution. As an example of how this sub-system can be implemented, FIG. 3 shows details of such a Mobile Marketing solution and how it interacts with other modules of the system. Of note, the Main Server—element 301 of FIG. 3 corresponds to Module 5—element 109 of FIG. 1, the Module 3—element 303 of FIG. 3 corresponds to Module 3—element 105 of FIG. 1, and both the wireless network servers—element 307 and Mobile Market Controller—element 309 of FIG. 3 correspond to Mobile Marketing System—element 113 of FIG. 1. Of further note, as in FIG. 1, the database (not shown) of Module 3—element 303 of FIG. 3 may store each user's preferences, each user's scheduled events (e.g., a particular user bought a ticket for a movie at a certain date/time), each user's online shopping history for stores in that particular mall, the license plate ID of each user's vehicle(s), sellers advertisement, setup data, etc. Further mobile devices 311A-311C may communicate with wireless network servers 307 for shopping, downloading, reservations, movie tickets, etc.

In one example, based on FIG. 3 and having this integration, the Smart Parking System can:
Recognize the user inside the mall (e.g., by Bluetooth MAC address, or positioning, or face recognition);
Discovering the user, the system (e.g., the Main Server) can use the license plate ID to get information about user preferences;
Having the preferences, the system (e.g., the Main Server) can send Bluetooth messages (e.g., mobile marketing)—and/or SMS, and/or e-mail, and/or mobile notifications—based on what user wants to buy/go/or desire;

Thus, the following is an example process flow:
1) User enters the mall website, informs the system that he's going to retail store “A” and also enters his vehicle's license plate ID;
2) The license plate ID is recognized when the user arrives at the mall;
3) The user is guided until he stops his vehicle, as close as possible of his destination;
4) The system recognizes this user and gets his preferences;
5) The system sends e.g., Bluetooth messages, having promotions of, e.g., CD, DVD, Wine, electronics, etc from retail store “A”;
6) The User can use this message to get a special price on one or more of the products.

In another example, in a case where the user parks the vehicle at a different parking space than the one the system assigned him to, the system (e.g., Module 5—element 109 of FIG. 1) recalculates for all the moving vehicles new parking spaces and gives to the moving vehicles the new parking space directions on the fly, in real-time (this may be carried out transparently to the users, such that the users are completely unaware of this event).

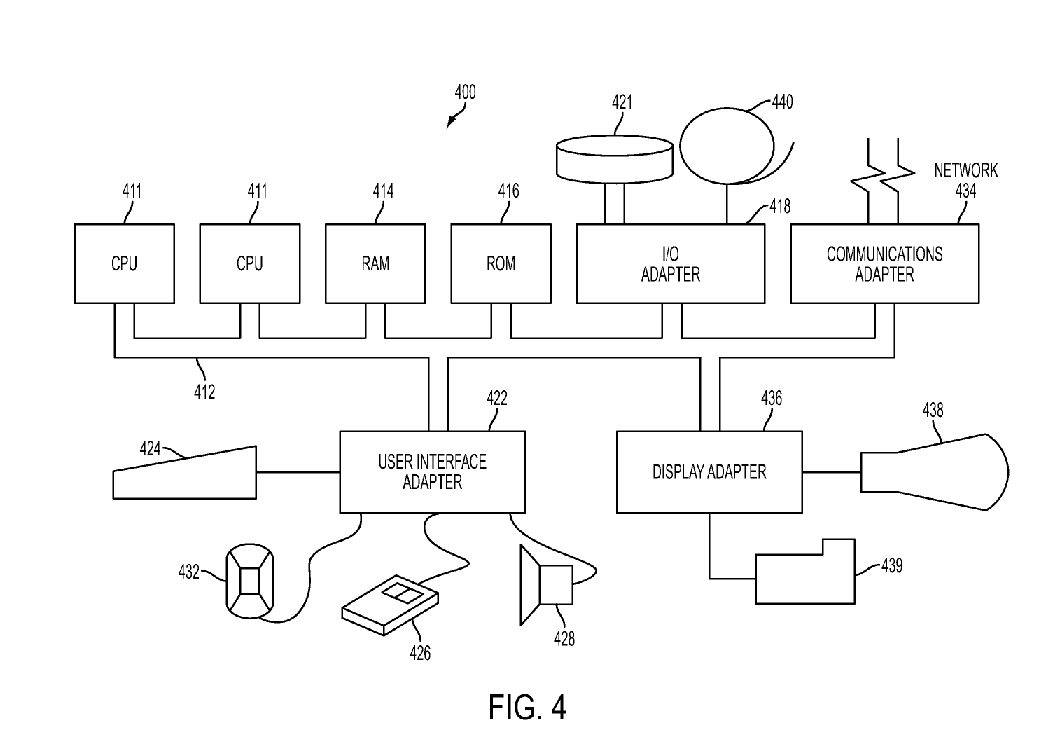

Referring now to FIG. 4, this Fig. shows a hardware configuration of computing system 400 according to an embodiment of the present invention. As seen, this hardware configuration has at least one processor or central processing unit (CPU) 411. The CPUs 411 are interconnected via a system bus 412 to a random access memory (RAM) 414, read-only memory (ROM) 416, input/output (I/O) adapter 418 (for connecting peripheral devices such as disk units 421 and tape drives 440 to the bus 412), user interface adapter 422 (for connecting a keyboard 424, mouse 426, speaker 428, microphone 432, and/or other user interface device to the bus 412), a communication adapter 434 for connecting the system 400 to a data processing network, the Internet, an Intranet, a local area network (LAN), etc., and a display adapter 436 for connecting the bus 412 to a display device 438 and/or printer 439 (e.g., a digital printer of the like).

As described herein, in one embodiment a method implemented by at least one computer for allocating a parking space in a parking lot of a mall is provided. In this embodiment, the allocation is for a first user from a plurality of users, the allocation is made after a vehicle arrives at an entrance to the parking lot, and the mall has a plurality of commercial establishments associated therewith.

Further, in this embodiment the method comprises the steps of:
receiving into a database associated with the at least one computer (see, e.g., elements 205, 203, 307, 309 and 311 of FIG. 2) a plurality of license plate ID's
receiving into the database associated with the at least one computer (see, e.g., elements 205, 203, 307, 309 and 311 of FIG. 2) at least one of:
   (a) a plurality of user preferences, each of the user preferences being associated with one of the plurality of users and each of the user preferences being associated with one of the license plate ID's;
   (b) a plurality of shopping histories, each of the shopping histories being associated with one of the plurality of users, each of the shopping histories comprising data indicative of at least one purchase made by a respective user from at least one of the commercial establishments, and each of the shopping histories being associated with one of the license plate ID's; and
   (c) a plurality of scheduled events, each of the scheduled events being associated with one of the plurality of users, each of the scheduled events comprising data indicative of at least one scheduled event associated with a respective user in connection with at least one of the commercial establishments, and each of the scheduled events being associated with one of the license plate ID's;
determining, by the at least one computer, a license plate ID of the vehicle at the entrance to the parking lot (see, e.g., element 101 of FIG. 1);
obtaining from the database associated with the at least one computer (see, e.g., element 109 of FIG. 1) at least one of: (a) one or more user preferences corresponding to the determined license plate ID; (b) one or more shopping histories corresponding to the determined license plate ID; and (c) one or more scheduled events corresponding to the determined license plate ID; and
allocating, by the at least one computer, a parking space (see, e.g., element 109 of FIG. 1) for the first user, wherein the allocation of the parking space is based at least in part upon at least one of: (a) the one or more user preferences corresponding to the determined license plate ID; (b) the one or more shopping histories corresponding to the determined license plate ID; and (c) the one or more scheduled events corresponding to the determined license plate ID.

In various examples, the user preferences may include all parameters that can be set by the driver (or other user) so the system can take them in consideration when selecting a parking space. Such parameters may include (but not be limited to): favorite stores, preferred mall exits, shopping categories, impairment/disability and/or elderly needs.

In various examples, a parking space may be allocated as follows: Each parking space in the system's database has its spatial coordinates tied to it. The system then first determines what's the ideal shopping mall entrance for that particular driver or other user (based on the distance of that entrance to whatever store he's most likely willing to go), then sorts the free parking spaces by their distance from this very shopping mall entrance. The closest is then selected and assigned to the driver (or other user).

In one example, the method may further comprise providing, by the at least one computer, directions to the allocated parking space (see, e.g., elements 109 and 111 of FIG. 1).

In another example, the directions to the allocated parking space may be provided by the at least one computer based at least in part upon providing by the at least one computer directions at each turn to be made while driving between the entrance to the parking lot and the allocated parking space (see, e.g., elements 109 and 111 of FIG. 1).

In another example, the method may further comprise receiving into the database associated with the at least one computer each of:
(a) the plurality of user preferences;
(b) the plurality of shopping histories; and
(c) the plurality of scheduled events.

In another example, each of the shopping histories may comprise data indicative of at least one of: (a) at least one physical purchase made by a respective user from at least one of the commercial establishments; and (b) at least one on-line purchase made by a respective user from at least one of the commercial establishments.

In another example, each of the scheduled events may comprise data indicative of at least one scheduled event associated with a respective user in connection with one of: (a) viewing of a movie at one of the commercial establishments; (b) eating at one of the commercial establishments; (c) drinking at one of the commercial establishments; (d) dancing at one of the commercial establishments; and (e) making a physical purchase at one of the commercial establishments.

In another example, the license plate ID of the vehicle at the entrance to the parking lot may be determined, by the at least one computer, based at least in part upon an optical character recognition process (see, e.g., elements 109 and 101 of FIG. 1).

In another example, the steps may be carried out in the order recited.

As described herein, in one embodiment a system for allocating a parking space in a parking lot of a mall is provided. In this embodiment, the allocation is for a first user from a plurality of users, the allocation is made after a vehicle arrives at an entrance to the parking lot, and the mall has a plurality of commercial establishments associated therewith.

Further, in this embodiment the system comprises one or more processor units configured for:
receiving into a database (see, e.g., elements 205, 203, 307, 309 and 311 of FIG. 2) a plurality of license plate ID's;
receiving into the database (see, e.g., elements 205, 203, 307, 309 and 311 of FIG. 2) at least one of:
   (a) a plurality of user preferences, each of the user preferences being associated with one of the plurality of users and each of the user preferences being associated with one of the license plate ID's;
   (b) a plurality of shopping histories, each of the shopping histories being associated with one of the plurality of users, each of the shopping histories comprising data indicative of at least one purchase made by a respective user from at least one of the commercial establishments, and each of the shopping histories being associated with one of the license plate ID's; and
   (c) a plurality of scheduled events, each of the scheduled events being associated with one of the plurality of users, each of the scheduled events comprising data indicative of at least one scheduled event associated with a respective user in connection with at least one of the commercial establishments, and each of the scheduled events being associated with one of the license plate ID's;
determining a license plate ID of the vehicle at the entrance to the parking lot (see, e.g., element 101 of FIG. 1);
obtaining from the database (see, e.g., element 109 of FIG. 1) at least one of: (a) one or more user preferences corresponding to the determined license plate ID; (b) one or more shopping histories corresponding to the determined license plate ID; and (c) one or more scheduled events corresponding to the determined license plate ID; and
allocating a parking space (see, e.g., element 109 of FIG. 1) for the first user, wherein the allocation of the parking space is based at least in part upon at least one of: (a) the one or more user preferences corresponding to the determined license plate ID; (b) the one or more shopping histories corresponding to the determined license plate ID; and (c) the one or more scheduled events corresponding to the determined license plate ID.

In various examples, the user preferences may include all parameters that can be set by the driver (or other user) so the system can take them in consideration when selecting a parking space. Such parameters may include (but not be limited to): favorite stores, preferred mall exits, shopping categories, impairment/disability and/or elderly needs.

In various examples, a parking space may be allocated as follows: Each parking space in the system's database has its spatial coordinates tied to it. The system then first determines what's the ideal shopping mall entrance for that particular driver or other user (based on the distance of that entrance to whatever store he's most likely willing to go), then sorts the free parking spaces by their distance from this very shopping mall entrance. The closest is then selected and assigned to the driver (or other user).

In one example, the system may further comprise one or more processor units configured for providing directions to the allocated parking space (see, e.g., elements 109 and 111 of FIG. 1).

In another example, the system may further comprise receiving into the database each of:
(a) the plurality of user preferences;
(b) the plurality of shopping histories; and
(c) the plurality of scheduled events.

In another example, each of the shopping histories may comprise data indicative of at least one of: (a) at least one physical purchase made by a respective user from at least one of the commercial establishments; and (b) at least one on-line purchase made by a respective user from at least one of the commercial establishments.

In another example, each of the scheduled events may comprise data indicative of at least one scheduled event associated with a respective user in connection with one of: (a) viewing of a movie at one of the commercial establishments; (b) eating at one of the commercial establishments; (c) drinking at one of the commercial establishments; (d) dancing at one of the commercial establishments; and (e) making a physical purchase at one of the commercial establishments.

In another example, the license plate ID of the vehicle at the entrance to the parking lot may be determined based at least in part upon an optical character recognition process (see, e.g., elements 109 and 111 of FIG. 1).

As described herein, in one embodiment an article of manufacture is provided. In this embodiment, the article of manufacture comprises at least one tangible computer readable device having a computer readable program code logic tangibly embodied therein to execute at least one machine instruction in a processing unit. The computer readable program code logic is for allocating a parking space in a parking lot of a mall. The allocation is for a first user from a plurality of users, the allocation is made after a vehicle arrives at an entrance to the parking lot, and the mall has a plurality of commercial establishments associated therewith.

Further, in this embodiment the computer readable program code logic, when executing, performs the following steps:
receiving into a database (see, e.g., elements 205, 203, 307, 309 and 311 of FIG. 2) a plurality of license plate ID's;
receiving into the database (see, e.g., elements 205, 203, 307, 309 and 311 of FIG. 2) at least one of:
   (a) a plurality of user preferences, each of the user preferences being associated with one of the plurality of users and each of the user preferences being associated with one of the license plate ID's;
   (b) a plurality of shopping histories, each of the shopping histories being associated with one of the plurality of users, each of the shopping histories comprising data indicative of at least one purchase made by a respective user from at least one of the commercial establishments, and each of the shopping histories being associated with one of the license plate ID's; and
   (c) a plurality of scheduled events, each of the scheduled events being associated with one of the plurality of users, each of the scheduled events comprising data indicative of at least one scheduled event associated with a respective user in connection with at least one of the commercial establishments, and each of the scheduled events being associated with one of the license plate ID's;
determining a license plate ID of the vehicle at the entrance to the parking lot (see, e.g., element 101 of FIG. 1);
obtaining from the database (see, e.g., element 109 of FIG. 1) at least one of: (a) one or more user preferences corresponding to the determined license plate ID; (b) one or more shopping histories corresponding to the determined license plate ID; and (c) one or more scheduled events corresponding to the determined license plate ID; and
allocating a parking space (see, e.g., element 109 of FIG. 1) for the first user, wherein the allocation of the parking space is based at least in part upon at least one of: (a) the one or more user preferences corresponding to the determined license plate ID; (b) the one or more shopping histories corresponding to the determined license plate ID; and (c) the one or more scheduled events corresponding to the determined license plate ID.

In various examples, the user preferences may include all parameters that can be set by the driver (or other user) so the system can take them in consideration when selecting a parking space. Such parameters may include (but not be limited to): favorite stores, preferred mall exits, shopping categories, impairment/disability and/or elderly needs.

In various examples, a parking space may be allocated as follows: Each parking space in the system's database has its spatial coordinates tied to it. The system then first determines what's the ideal shopping mall entrance for that particular driver or other user (based on the distance of that entrance to whatever store he's most likely willing to go), then sorts the free parking spaces by their distance from this very shopping mall entrance. The closest is then selected and assigned to the driver (or other user).

In one example, the computer readable program code logic, when executing, further performs the step of providing directions to the allocated parking space (see, e.g., elements 109 and 111 of FIG. 1).

In another example, the computer readable program code logic, when executing, further performs the step of receiving into the database each of:
(a) the plurality of user preferences;
(b) the plurality of shopping histories; and
(c) the plurality of scheduled events.

In another example, each of the shopping histories comprises data indicative of at least one of: (a) at least one physical purchase made by a respective user from at least one of the commercial establishments; and (b) at least one on-line purchase made by a respective user from at least one of the commercial establishments.

In another example, each of the scheduled events comprises data indicative of at least one scheduled event associated with a respective user in connection with one of: (a) viewing of a movie at one of the commercial establishments; (b) eating at one of the commercial establishments; (c) drinking at one of the commercial establishments; (d) dancing at one of the commercial establishments; and (e) making a physical purchase at one of the commercial establishments.

In another example, the license plate ID of the vehicle at the entrance to the parking lot is determined based at least in part upon an optical character recognition process (see, e.g., elements 109 and 111 of FIG. 1).

Reference will now be made to another example process flow according to an embodiment of the invention:
the user optionally sets his\her preferences by visiting the mall's website, before the user goes to the mall;
the user arrives at the parking lot of the mall;
the parking lot entrance camera detects the vehicle's license plate ID and the existence of the international symbol of accessibility (if present);
if the user did not set his preferences before, he\she can select to which store he\she primarily wants to go by means of a touch screen (“manual” destination selection device) at the entrance;
a module (see, e.g., Module 5—element 109 of FIG. 1) then assigns the user an empty parking space, based on his\her destination;
an entrance LCD screen (see, e.g., Module 6—element 111 of FIG. 1), gives him the first direction;
each parking lot turn contains a camera (see, e.g., Module 1—element 101 of FIG. 1) that will detect the vehicle's license plate ID;
other LCD screens (each of which may be part of a Module 6—element 111 of FIG. 1) will point the next direction he\she needs to follow to arrive at his destination (each of a plurality of additional LCD screens may give subsequent directions, as needed);
given that the system (see, e.g., Module 5—element 109 of FIG. 1) knows not only where each vehicle is parked due the information provided by Module 4—element 107 of FIG. 1, but the location of each moving vehicle, the system (see, e.g., Module 5—element 109 of FIG. 1) can also point the user to the fastest path (e.g., since the vehicles that are moving out of the parking space can block the vehicle traffic);
the user will be guided until he gets to the best parking space, based, for example, on his preferences.

In another example, various embodiments may make inferences to calculate the best parking space (that would fit the user scheduled events, user shopping history, user preferences, historical parking lot usage, current parking lot usage and a forecast of the parking lot usage at a desired time (e.g., a time indicated by the user implicitly or explicitly)) and also suggest the best time for arriving at the parking lot, based at least in part (for example) on the usage history (e.g., if you arrive at 7:35 PM, there's a 92% probability of finding an available parking space in the 1st row near to the entrance; if you arrive at 7:40 PM, the probability is 87%). Based on this information, the user can choose, for example, to leave home early or to pick another movie showing time, such as later on that night).

In another example, various embodiments of the present invention may not necessarily reserve a parking space ahead of time but, rather, allocate a space when a car enters the parking lot. Such embodiments may provide relatively easy integration with a conventional parking lot control system and would typically not require a policy system to ensure that the users will only park in their reserved spaces. Thus, in such embodiments, the probability of finding an available parking space at a given date and time is calculated, instead of reserving a parking space.

In another example, various embodiments may take into account the user's preferences, the user's characteristics (e.g., a physically challenged and/or elderly person) and/or (particularly for parking lots in large malls) the parking space nearest to the user's destination.

Various embodiments may utilize any desired system(s) and/or method(s) to determine the list of available parking spaces in a parking lot. In one example, sensor networks, spread across the parking lot, may provide information regarding the state of each parking space. In another example, cameras and image-processing algorithms may be used to detect whether a certain parking area is full or not. Yet another example is provided by U.S. Pat. No. 6,650,250 in the name of Muraki, entitled PARKING LOT GUIDANCE SYSTEM AND PARKING LOT GUIDANCE PROGRAM (which is incorporated herein by reference in its entirety).

Various embodiments may utilize any desired system(s) and/or method(s) to inform the user the directions to a certain parking space. In one example, a network-capable system composed of a number of displays may be provided. Yet another example is provided by U.S. Pat. No. 6,650,250 in the name of Muraki, entitled PARKING LOT GUIDANCE SYSTEM AND PARKING LOT GUIDANCE PROGRAM (which is incorporated herein by reference in its entirety).

In another example, various embodiments may integrate a reservation mechanism based on the user preferences and on-line shopping activity (e.g., in virtual stores which have physical stores in that particular mall).

In another example, mobile marketing may be based on a user's shopping profile (which may be built, for example, based on the stores he chooses at the parking lot entrance).

In another example, embodiments may comprise software as a service (for example, software billed by usage rather than licensed per CPU or user).

In another example, embodiments may comprise services-oriented software (for example, software implemented according to Services Oriented Architecture).

In another example, use of expert system technologies may be applied to efficiently solve parking space allocation (e.g., within structures).

In another example, various embodiments may be aligned with the Smarter Planet initiative.

In another example, various embodiments may be implemented as a standalone product (e.g., to improve the infrastructure of buildings with a high demand for parking spaces and allocation).

In another example, various embodiments may improve the driver's experience in a parking lot by providing assistance in finding parking spaces. Various specific examples may include taking into account the driver's preference(s) as well as the inference of such preference parameters given the driver's shopping and parking history (including which stores were accessed more frequently and when exactly that particular driver had required a parking space).

In another example, various embodiments may provide for inference regarding a user's probable destination(s) and/or the ability to add scheduled events (such as buying a ticket for a movie) and to calculate the probability of finding an available parking space in a parking lot, on that exact same date and time (e.g., within plus or minus x number of minutes).

As described herein, various embodiments provide an efficient system and method for allocating parking spaces for vehicles, comprising: (a) placing a selection device near a parking lot entrance to gather user (e.g., driver and/or passenger) preferences and store the preferences in a database; and (b) determining (e.g., calculating) the best parking space for the vehicle based on: (i) the user preferences stored in the database and/or a user history (e.g., shopping center nearest entrance, store to which driver wants to go, the mall's entrance he wants to go) stored in the database.

As described herein, under various embodiments user preferences may be assigned to a certain license plate ID, so that the user doesn't need to input his preferences in the parking lot entrance if he has already done that using, for example, a webportal or website. In additional, shopping history may be used to calculate (e.g., via inference) the probable other destinations of the user, and such information, including the user's shopping history, user's preferences, parking lot usage history, current parking lot usage, may be used to calculate (e.g., via inference) the best parking space. In one example, if the user is already in the parking lot entrance, then the calculated best parking space may be shown to the user. In another example, if the user is looking for a date/time in the future (e.g., if the user is looking for the best date/time to watch a movie next week) the probability of finding an available parking space at that date/time may be provided to the user such as via a web browser (further, under various embodiments the best date/time based on the available information may be presented to the user such as via a web browser).

In other examples, inferences may be calculated as follows (input parameters, calculation algorithms, output values):
Input=set of preferences, time
Calculation=algorithm based on learning, having as input all the historical information and the user preferences, including where the user is going. The algorithm will calculate how many times the driver (or other user) went to that parking lot with a set of preferences and at a particular time of the day, and also in how many of these attempts the system could find an ideal parking space. The threshold for what parking space can be considered ideal can be set by the driver (or other user) by providing feedback of his parking experience, or by the system's owner.
Output=The probability will then be the latter number divided by the first.

In other examples, a tool that implements some Predictive Analytics can be used to analyze all the historical data and confront with the user preferences (that is, utilize the user preferences), in order to generate the expected output (time (e.g., Hour & minutes) versus the Probability to find the best parking space).

In other examples, any steps described herein may be carried out in any appropriate desired order.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. The containment (or storage) of the program may be non-transitory.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any programming language or any combination of one or more programming languages, including an object oriented programming language such as Java, Smalltalk, C++ or the like or a procedural programming language, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described herein with reference to flowchart illustrations and/or block diagrams of methods, systems and/or computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus or other devices provide processes for implementing the functions/acts specified in the flowchart and/or block diagram block or blocks.

The flowcharts and block diagrams in the figures illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

It is noted that the foregoing has outlined some of the objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the features and applications of the invention. Other beneficial results can be realized by applying the disclosed invention in a different manner or modifying the invention in ways known to those familiar with the art. In addition, all of the examples disclosed herein are intended to be illustrative, and not restrictive.

1. A method implemented by at least one computer for allocating a parking space in a parking lot of a mall, wherein the allocation is for a first user from a plurality of users, and wherein the mall has a plurality of commercial establishments associated therewith, the method comprising the steps of:
receiving into a database associated with the at least one computer a plurality of license plate ID's;
receiving into the database associated with the at least one computer at least one of:
(a) a plurality of shopping histories, each of the shopping histories being associated with one of the plurality of users, each of the shopping histories comprising data indicative of at least one purchase made by a respective user from at least one of the commercial establishments, and each of the shopping histories being associated with one of the license plate ID's; and
(b) a plurality of scheduled events, each of the scheduled events being associated with one of the plurality of users, each of the scheduled events comprising data indicative of at least one scheduled event associated with a respective user in connection with at least one of the commercial establishments, and each of the scheduled events being associated with one of the license plate ID's;
determining, by the at least one computer, a license plate ID of a vehicle at the entrance to the parking lot;
obtaining from the database associated with the at least one computer at least one of: (a) one or more shopping histories corresponding to the determined license plate ID; and (b) one or more scheduled events corresponding to the determined license plate ID; and
allocating by the at least one computer, after the vehicle arrives at the entrance to the parking lot, a particular parking space for the first user selected from a plurality of possible parking spaces, wherein the allocation of the particular parking space selected from the plurality of possible parking spaces is based at least in part upon at least one of: (a) the one or more shopping histories corresponding to the determined license plate ID; and (b) the one or more scheduled events corresponding to the determined license plate ID.

2. The method of claim 1, further comprising providing, by the at least one computer, directions to the allocated parking space.

3. The method of claim 2, wherein the directions to the allocated parking space are provided by the at least one computer based at least in part upon providing by the at least one computer directions at each turn to be made while driving between the entrance to the parking lot and the allocated parking space.

4. The method of claim 1, further comprising receiving into the database associated with the at least one computer each of:
(a) the plurality of shopping histories; and
(b) the plurality of scheduled events.

5. The method of claim 1, wherein each of the shopping histories comprises data indicative of at least one of: (a) at least one physical purchase made by a respective user from at least one of the commercial establishments; and (b) at least one on-line purchase made by a respective user from at least one of the commercial establishments.

6. The method of claim 1, wherein each of the scheduled events comprises data indicative of at least one scheduled event associated with a respective user in connection with one of: (a) viewing of a movie at one of the commercial establishments; (b) eating at one of the commercial establishments; (c) drinking at one of the commercial establishments; (d) dancing at one of the commercial establishments; and (e) making a physical purchase at one of the commercial establishments.

7. The method of claim 1, wherein the license plate ID of the vehicle at the entrance to the parking lot is determined, by the at least one computer, based at least in part upon an optical character recognition process.

8. The method of claim 1, wherein the steps are carried out in the order recited.

9. A system for allocating a parking space in a parking lot of a mall, wherein the allocation is for a first user from a plurality of users, and wherein the mall has a plurality of commercial establishments associated therewith, the system comprising one or more processor units configured for:
receiving into a database a plurality of license plate ID's;
receiving into the database at least one of:
(a) a plurality of shopping histories, each of the shopping histories being associated with one of the plurality of users, each of the shopping histories comprising data indicative of at least one purchase made by a respective user from at least one of the commercial establishments, and each of the shopping histories being associated with one of the license plate ID's; and
(b) a plurality of scheduled events, each of the scheduled events being associated with one of the plurality of users, each of the scheduled events comprising data indicative of at least one scheduled event associated with a respective user in connection with at least one of the commercial establishments, and each of the scheduled events being associated with one of the license plate ID's;
determining a license plate ID of a vehicle at the entrance to the parking lot;
obtaining from the database at least one of: (a) one or more shopping histories corresponding to the determined license plate ID; and (b) one or more scheduled events corresponding to the determined license plate ID; and
allocating, after the vehicle arrives at the entrance to the parking lot, a particular parking space for the first user selected from a plurality of possible parking spaces, wherein the allocation of the particular parking space selected from the plurality of possible parking spaces is based at least in part upon at least one of: (a) the one or more shopping histories corresponding to the determined license plate ID; and (b) the one or more scheduled events corresponding to the determined license plate ID.

10. The system of claim 9, further comprising one or more processor units configured for providing directions to the allocated parking space.

11. The system of claim 9, further comprising receiving into the database each of:
(a) the plurality of shopping histories; and
(b) the plurality of scheduled events.

12. The system of claim 9, wherein each of the shopping histories comprises data indicative of at least one of: (a) at least one physical purchase made by a respective user from at least one of the commercial establishments; and (b) at least one on-line purchase made by a respective user from at least one of the commercial establishments.

13. The system of claim 9, wherein each of the scheduled events comprises data indicative of at least one scheduled event associated with a respective user in connection with one of: (a) viewing of a movie at one of the commercial establishments; (b) eating at one of the commercial establishments; (c) drinking at one of the commercial establishments; (d) dancing at one of the commercial establishments; and (e) making a physical purchase at one of the commercial establishments.

14. The system of claim 9, wherein the license plate ID of the vehicle at the entrance to the parking lot is determined based at least in part upon an optical character recognition process.

15. An article of manufacture, comprising:
at least one tangible computer readable device having a computer readable program code logic tangibly embodied therein to execute at least one machine instruction in a processing unit for allocating a parking space in a parking lot of a mall, wherein the allocation is for a first user from a plurality of users, and wherein the mall has a plurality of commercial establishments associated therewith, the computer readable program code logic, when executing, performing the following steps:
receiving into a database a plurality of license plate ID's;
receiving into the database at least one of:
(a) a plurality of shopping histories, each of the shopping histories being associated with one of the plurality of users, each of the shopping histories comprising data indicative of at least one purchase made by a respective user from at least one of the commercial establishments, and each of the shopping histories being associated with one of the license plate ID's; and
(b) a plurality of scheduled events, each of the scheduled events being associated with one of the plurality of users, each of the scheduled events comprising data indicative of at least one scheduled event associated with a respective user in connection with at least one of the commercial establishments, and each of the shopping histories being associated with one of the license plate ID's;
determining a license plate ID of a vehicle at the entrance to the parking lot;
obtaining from the database at least one of: (a) one or more shopping histories corresponding to the determined license plate ID; and (b) one or more scheduled events corresponding to the determined license plate ID; and
allocating, after the vehicle arrives at the entrance to the parking lot, a particular parking space for the first user selected from a plurality of possible parking spaces, wherein the allocation of the particular parking space selected from the plurality of possible parking spaces is based at least in part upon at least one of: (a) the one or more shopping histories corresponding to the determined license plate ID; and (b) the one or more scheduled events corresponding to the determined license plate ID.

16. The article of manufacture of claim 15, the computer readable program code logic, when executing, further performing the step of providing directions to the allocated parking space.

17. The article of manufacture of claim 15, the computer readable program code logic, when executing, further performing the step of receiving into the database each of:
(a) the plurality of shopping histories; and
(b) the plurality of scheduled events.

18. The article of manufacture of claim 15, wherein each of the shopping histories comprises data indicative of at least one of: (a) at least one physical purchase made by a respective user from at least one of the commercial establishments; and (b) at least one on-line purchase made by a respective user from at least one of the commercial establishments.

19. The article of manufacture of claim 15, wherein each of the scheduled events comprises data indicative of at least one scheduled event associated with a respective user in connection with one of: (a) viewing of a movie at one of the commercial establishments; (b) eating at one of the commercial establishments; (c) drinking at one of the commercial establishments; (d) dancing at one of the commercial establishments; and (e) making a physical purchase at one of the commercial establishments.

20. The article of manufacture of claim 15, wherein the license plate ID of the vehicle at the entrance to the parking lot is determined based at least in part upon an optical character recognition process.
